(19) United States
(12) Patent Application Publication
(10) Pub. No.: US 2019/0230244 A1
(43) Pub. Date: Jul. 25, 2019

(54) DATA SAVING APPARATUS

(71) Applicant: KYOCERA Document Solutions Inc., Osaka (JP)

(72) Inventor: Akifumi SETO, Osaka-shi (JP)

(73) Assignee: KYOCERA Document Solutions Inc., Osaka (JP)

(21) Appl. No.: 16/250,038

(22) Filed: Jan. 17, 2019

(30) Foreign Application Priority Data
Jan. 19, 2018 (JP) 2018-007151

(51) Int. Cl. H04N 1/21; H04L 29/08; H04N 1/00

(52) U.S. Cl. CPC H04N 1/2166; H04L 67/06; H04N 2201/0039; H04N 1/00209; H04L 67/1097

(57) ABSTRACT

A data saving apparatus includes a data acquiring section, a file generating section, a file saving section, and a save notification section. The data acquiring section acquires data and acquires settings of a file name, a file format, and a save folder. The file generating section generates a file with the file name and the file format for the data. The file saving section saves the file in the save folder. The save notification section notifies a notification target of a path to the save folder and the file name when the file format is set as editable, and notifies the notification target of a path to the file when the file format is set as uneditable.

### INCORPORATION BY REFERENCE

The present application claims priority under 35 U.S.C. § 119 to Japanese Patent Application No. 2018-007151, filed on Jan. 19, 2018. The contents of this application are incorporated herein by reference in their entirety.

### BACKGROUND

The present disclosure relates to a data saving apparatus.

A known system generates image data by scanning an original document through a document reading section of an image forming apparatus, saves a file of the image data in a network folder, and notifies a user of a path to the file. Having been notified of the file path, the user can click the file path to access the file through the network.

### SUMMARY

A data saving apparatus according to an aspect of the present disclosure is a data saving apparatus for saving in a save folder which is one of a plurality of folders provided in a network storage area. The data saving apparatus includes a data acquiring section, a file generating section, a file saving section, and a save notification section. The data acquiring section acquires the data and acquires settings of a file name, a file format, and a save folder. The save folder is a save target folder for the data. The file generating section generates a file with the file name and the file format for the data acquired by the data acquiring section. The file saving section saves the file generated by the file generating section in the save folder. The save notification section determines whether the file format is set as editable or uneditable, notifies a notification target of a path to the save folder in which the file is saved and the file name when the file format is set as editable, and notifies the notification target of a path to the file saved in the save folder when the file format is set as uneditable.

### BRIEF DESCRIPTION OF THE DRAWINGS

FIG. 1 is a block diagram illustrating a general configuration of an embodiment of a data saving apparatus according to the present disclosure.

FIG. 2A is a first diagram illustrating notification target information. FIG. 2B is a second diagram illustrating notification target information. FIG. 2C is a first diagram illustrating editability information. FIG. 2D is a second diagram illustrating editability information.

FIG. 3A is a first diagram illustrating information notified of through a save notification section. FIG. 3B is a second diagram illustrating information notified of through the save notification section. FIG. 3C is a third diagram illustrating information notified of through the save notification section. FIG. 3D is a fourth diagram illustrating information notified of through the save notification section.

### DETAILED DESCRIPTION

The following describes an embodiment of the present disclosure in detail with reference to the accompanying drawings.

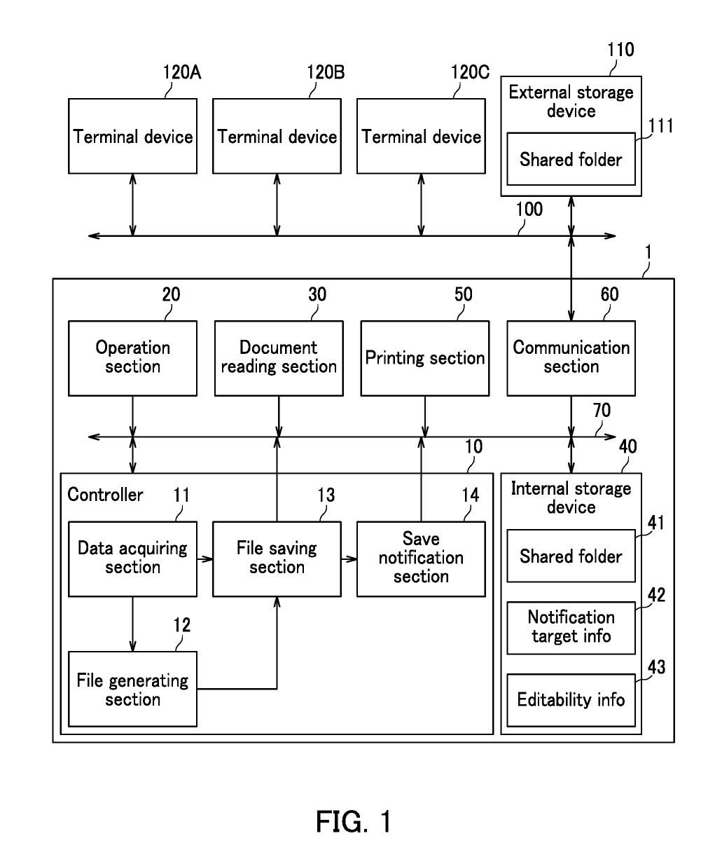

A data saving apparatus 1 according to the present embodiment is for example an image forming apparatus such as a copier or a multifunction peripheral (MFP). As illustrated in FIG. 1, the data saving apparatus 1 is connected to a network 100 such as the Internet or a local area network (LAN). The data saving apparatus 1 exchanges data with a terminal device 120A, a terminal device 120B, and a terminal device 120C through the network 100. The terminal device 120A, the terminal device 120B, and the terminal device 120C are personal computers, for example. The data saving apparatus 1 exchanges data with an external storage device 110. A shared folder 111 is provided in the external storage device 110. The terminal device 120A, the terminal device 120B, and the terminal device 120C can access the shared folder 111. The network 100 may be any of the following: a wired network, a wireless network, or a combination of wired and wireless networks. The shared folder 111 is a first example of a folder provided in a network storage area according to the present disclosure.

The data saving apparatus 1 includes a plurality of function blocks. The function blocks include a controller 10, an operation section 20, a document reading section 30, an internal storage device 40, a printing section 50, and a communication section 60. The function blocks are connected to each other by a system bus 70.

The operation section 20 is a device which receives input from an external section such as a keyboard. The operation section 20 for example receives input of an instruction according to a document reading operation by the document reading section 30 and receives input of an instruction according to a printing operation by the printing section 50. The operation section 20 receives settings of a file name, a file format, and a save folder. Note that the settings of the file name, the file format, and the save folder may be preset defaults and not received each time. The save folder indicates a folder of a data save destination among folders provided in the network storage area. Data means either or both image data and character data, for example.

The document reading section 30 is a scanner device which scans an original document to read data. When saving the data, the data saving apparatus 1 converts the data into a file with the set file name and file format, and saves the file to the set save folder. Note that the data saving apparatus 1 may acquire data through the communication section 60 without reading data through the document reading section 30. The communication section 60 is connectable to a network such as the Internet. The data saving apparatus 1 may also acquire the data through a storage medium such as flash memory or a digital versatile disc (DVD).

The internal storage device 40 is a storage device such as semiconductor memory or a hard disk drive (HDD). A shared folder 41 is provided in the internal storage device 40. The terminal device 120A, the terminal device 120B, and the terminal device 120C can access the shared folder 41. Notification target information 42 and editability information 43 are stored in the internal storage device 40. The shared folder 41 is a second example of a folder provided in the network storage area according to the present disclosure.

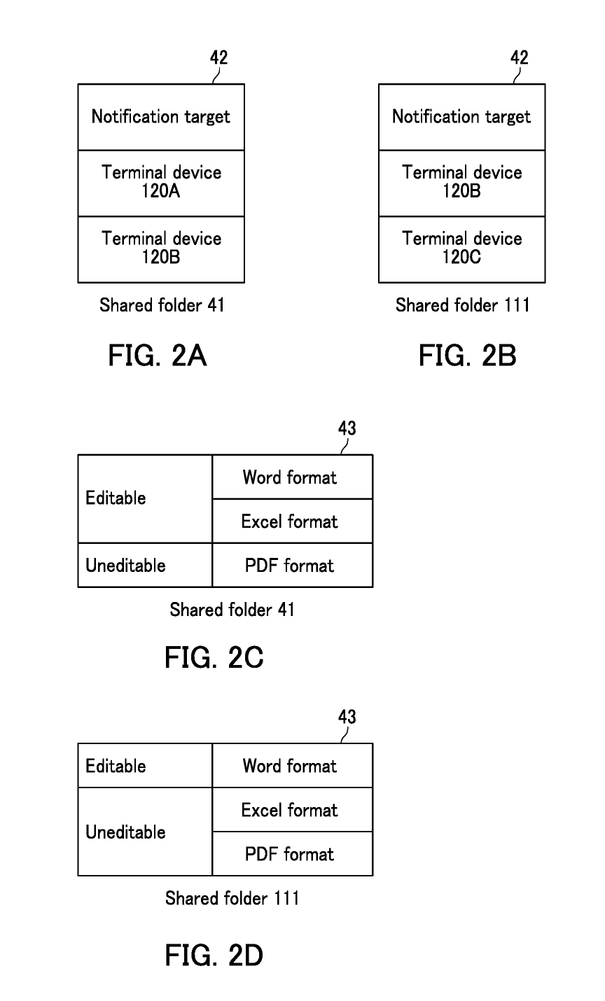

In the notification target information 42, notification targets to be notified of file saves are set corresponding to each of a plurality of folders. According to the present embodiment, the folders include the shared folder 41 and the shared folder 111. According to the present embodiment, the shared folder 41 of the internal storage device 40 and the shared folder 111 of the external storage device 110 are configured to be settable as save folders for files. In the notification target information 42 according to the present embodiment, the notification target set for the shared folder 41 differs from the notification target set for the shared folder 111. As illustrated in FIG. 2A, the terminal device 120A and the terminal device 120B are set as notification targets for the shared folder 41 in the notification target information 42. Accordingly, the terminal device 120A and the terminal device 120B are notification targets when a file is saved to the shared folder 41. As illustrated in FIG. 2B, the terminal device 120B and the terminal device 120C are set as notification targets for the shared folder 111 in the notification target information 42. Accordingly, the terminal device 120B and the terminal device 120C are notification targets when a file is saved to the shared folder 111.

File formats treated as editable and file formats treated as uneditable are set in the editability information 43. The editability information 43 can be registered for each folder. According to the present embodiment, registration content of the editability information 43 for the shared folder 41 differs from registration content of the editability information 43 for the shared folder 111. As illustrated in FIG. 2C, in the editability information 43, files of WORD (registered Japanese trademark, omitted hereafter) and EXCEL (registered Japanese trademark, omitted hereafter) formats developed by Microsoft Corporation are set as editable while a file of a Portable Document Format (PDF) developed by Adobe Systems Inc. is set as uneditable in the shared folder 41. Accordingly, in a situation in which files are saved in the shared folder 41, WORD files and EXCEL files among the files are saved as editable files but PDF files among the files are saved as uneditable files. As illustrated in FIG. 2D, in the editability information 43, WORD files are set as editable files but EXCEL and PDF files are set as uneditable files in the shared folder 111. Accordingly, in a situation in which files are saved in the shared folder 111, WORD files among the files are saved as editable files but EXCEL and PDF files among the files are saved as uneditable files.

The printing section 50 is for example a printer which forms an image represented by data on recording paper by outputting the data on the recording paper.

The communication section 60 includes either or both of a modem and an I/O controller, for example. The communication section 60 executes a predetermined protocol and performs exchange of data between the terminal device 120A, the terminal device 120B, the terminal device 120C, and the external storage device 110 through the network 100 based on an instruction of the controller 10.

The controller 10 for example includes a central processing unit (CPU), read-only memory (ROM), and random-access memory (RAM), and functions as a microcomputer information processor. A control program for performing operation control of the data saving apparatus 1 is stored in the ROM. The CPU of the controller 10 controls operation of the data saving apparatus 1 by reading the control program stored in the ROM, loading the control program into the RAM, and executing the control program.

The controller 10 functions as a data acquiring section 11, a file generating section 12, a file saving section 13, and a save notification section 14.

The data acquiring section 11 acquires the data to be saved and acquires the settings of the file name, the file format, and the save folder.

According to the present embodiment, the document reading section 30 scans an original document to read the data. The data acquiring section 11 then acquires the data read by the document reading section 30 from the document reading section 30. However, the present disclosure is not limited as such. For example, the communication section 60 may receive the data through the network 100 from an external device such as the terminal device 120A. The data acquiring section 11 then acquires the data through the communication section 60. The external device for example is a personal computer that is communicably connected to the data saving apparatus 1 in a wired or wireless manner, such as the terminal devices 120A to 120C.

According to the present embodiment, the operation section 20 receives the settings of the file name, the file format, and the save folder. The data acquiring section 11 then acquires the settings of the file name, the file format, and the save folder received by the operation section 20 from the operation section 20. However, the present embodiment is not limited as such. For example, the external device may receive the settings of the file name, the file format, and the save folder. In this case, the communication section 60 receives information indicating the settings of the file name, the file format, and the save folder received by the external device from the external device through the communication section 60.

The file generating section 12 generates a file with the set file name and file format for the data acquired by the data acquiring section 11. The file generating section 12 may include an optical character recognition (OCR) function. In this case, the file generating section 12 generates character data by performing an OCR process on the data when converting the data to a file as character data.

The file saving section 13 saves the file generated by the file generating section 12 in the set save folder.

The save notification section 14 determines whether the file format of the saved file is set as editable or uneditable based on the editability information 43 corresponding to the save folder. The save notification section 14 then notifies the notification target registered in the notification target information 42 corresponding to the save folder of a path to the folder (save folder) in which the file is saved and the file name of the saved file when the file format of the saved file is set as editable. Alternatively, the save notification section 14 notifies the notification target registered in the notification target information 42 corresponding to the save folder of a path to the saved file when the file format of the saved file is set as uneditable. Note that the notification method in the present disclosure is not limited to a notification method through the save notification section 14, and can be implemented by any of notification through email, various groupware, and the like, for example.

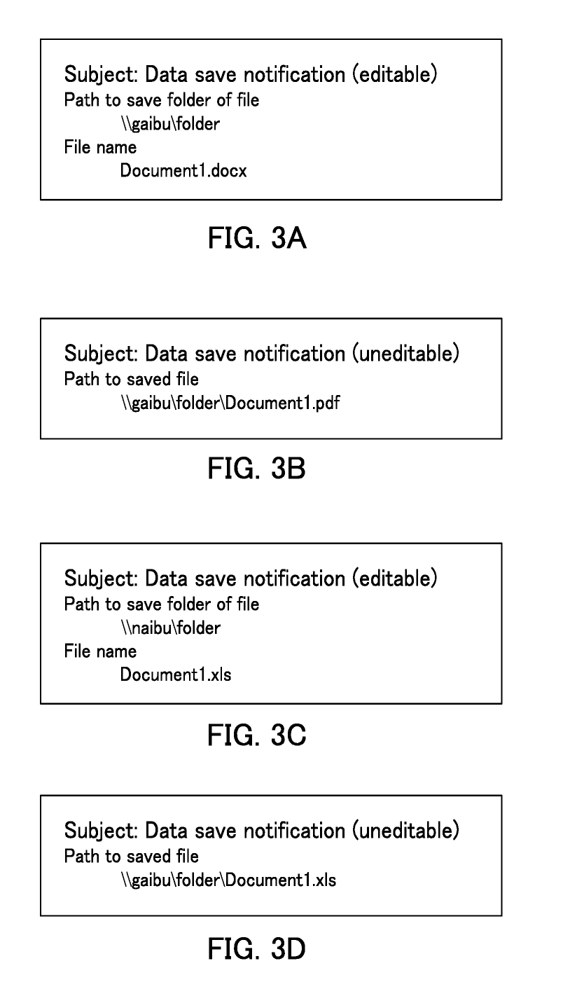

FIGS. 3A to 3D illustrate examples of notifications by the save notification section 14. FIG. 3A illustrates an example of a notification when the file name is set as document1, the file format is set as WORD, and the save folder is set as the shared folder 111. As illustrated in FIG. 2D, WORD files are set as editable in the editability information 43 corresponding to the shared folder 111. Accordingly, the save notification section 14 notifies a first notification target of the path to the shared folder 111 and document1.docx which is the file name of the file saved in the shared folder 111 when a WORD file is saved in the shared folder 111. As illustrated in FIG. 2B, the first notification target is the notification target (terminal device 120B and terminal device 120C) registered in the notification target information 42 corresponding to the shared folder 111. Note that “gaibu” in the path to the shared folder 111 is the device name of the external storage device 110 and “folder” is the folder name of the shared folder 111.

Therefore, in the terminal device 120B and the terminal device 120C, the shared folder 111 opens when the user clicks the path to the shared folder 111, but the file does not open. Accordingly, the user can be prevented from putting the file in an uneditable state for another user by unintentionally opening the file: document1.docx. The user wishing to access (view and edit) the file can open the file by clicking the file: document1.docx in the shared folder 111.

FIG. 3B illustrates an example of a notification when the file name is set as document1, the file format is set as PDF, and the save folder is set as the shared folder 111. As illustrated in FIG. 2D, PDF files are set as uneditable in the editability information 43 corresponding to the shared folder 111. Accordingly, the save notification section 14 notifies the first notification target (terminal device 120B and terminal device 120C) of the path to the file: document1.pdf saved in the shared folder 41 when a PDF file is saved in the shared folder 111.

Therefore, in the terminal device 120B and the terminal device 120C, the user can click the path to the file: document1.pdf to open the file. In this case, another user can also open the file in read-only mode. However, the other user is not hindered from only viewing document1.pdf because it is set as an uneditable file.

FIG. 3C illustrates an example of a notification when the file name is set as document1, the file format is set as EXCEL, and the save folder is set as the shared folder 41. As illustrated in FIG. 2C, EXCEL files are set as editable in the editability information 43 corresponding to the shared folder 41. Accordingly, the save notification section 14 notifies a second notification target of the path to the shared folder 41 and document1.xls which is the file name of the file saved in the shared folder 41 when an EXCEL file is saved in the shared folder 41. As illustrated in FIG. 2A, the second notification target is the notification target (terminal device 120A and terminal device 120B) registered in the notification target information 42 corresponding to the shared folder 41. Note that “naibu” in the path to the shared folder 41 is the device name of the internal storage device 40 and “folder” is the folder name of the shared folder 41.

FIG. 3D illustrates an example of a notification when the file name is set as document1, the file format is set as EXCEL, and the save folder is set as the shared folder 111. As illustrated in FIG. 2D, EXCEL files are set as uneditable in the editability information 43 corresponding to the shared folder 111. Accordingly, the save notification section 14 notifies the first notification target (terminal device 120B and terminal device 120C) of the path to the file: document1.xls saved in the shared folder 111 when an EXCEL file is saved in the shared folder 111.

In the above configuration, an EXCEL file is set as an uneditable file in the shared folder 111 despite being set as an editable file in the shared folder 41. Accordingly, editability of files of the same format can be changed by differentiating the save target folder (save folder).

In the notifications by the save notification section 14 as illustrated in FIGS. 3A to 3D, the user who receives the notification can easily understand the treatment of the saved file when information is displayed that indicates whether the file saved in the save folder is editable or uneditable, which is ideal.

According to the present embodiment as described above, the data saving apparatus 1 saves data in the save folder which is one of a plurality of folders (shared folder 41 and shared folder 111) provided in the network storage area. The data saving apparatus 1 includes the data acquiring section 11, the file generating section 12, the file saving section 13, and the save notification section 14. The data acquiring section 11 acquires data and acquires the settings of the file name, the file format, and the save folder. According to the present embodiment, the save folder is either the shared folder 41 or the shared folder 111. The file generating section 12 generates a file with the set file name and file format for the data acquired by the data acquiring section 11. The file saving section 13 saves the file generated by the file generating section 12 in the save folder. The save notification section 14 determines whether the file format is set as editable or uneditable. When the file format is set as editable, the save notification section 14 notifies the notification target of the path to the save folder in which the file is saved and the file name. When the file format is set as uneditable, the save notification section 14 notifies the notification target of the path to the file saved in the save folder. Through this configuration, the save folder opens when the user clicks the path notified of by the save notification section 14 in a case where the file saved in the save folder is an editable file, but the file does not open. Accordingly, the user can be prevented from putting the file in an uneditable state for another user by unintentionally opening the file. When the user wishes to access (view and edit) the file, the user opens the file by clicking the file in the save folder. When the file saved in the save folder is an uneditable file, the user can open the file by clicking the path notified of by the save notification section 14.

The data saving apparatus 1 includes the internal storage device 40 which stores the editability information 43 therein. The internal storage device 40 is an example of editability information storage according to the present disclosure. File formats treated as editable and file formats treated as uneditable are set corresponding to each of the folders in the editability information 43. The save notification section 14 determines whether the file format of the saved file is set as editable or uneditable based on the editability information 43 corresponding to the save folder. Through this configuration, editability of files of the same file format can be changed according to the save folder.

The internal storage device 40 stores the notification target information 42 therein. The internal storage device 40 is an example of notification target information storage according to the present disclosure. In the notification target information 42, the notification target is set according to each of the folders. One of the folders is set as the save folder. The save notification section 14 sets the notification target based on the notification target information 42 corresponding to the save folder. Through this configuration, different notification targets can be set for save folders.

Information indicating whether the file saved in the save folder is editable or uneditable is indicated in the notification by the save notification section 14. Through this configuration, the user receiving the notification can easily understand the treatment of the saved file.

According to the present embodiment, the save folder is selected from the shared folder 41 and the shared folder 111. That is, according to the present embodiment, there is a plurality of folders that can be save folders. However, the present disclosure is not limited as such. Only one folder may be set as the save folder. For example, the save folder may be set as the shared folder 41 only. In this case, the operation section 20 or the external device receives the settings of the file name and the file format. The data acquiring section 11 then acquires the settings of the file name and the file format from the operation section 20 or the external device. The file generating section 12 then generates a file with the file name and the file format for the data acquired by the data acquiring section 11. The file saving section 13 then saves the file generated by the file generating section 12 in the save folder. The save notification section 14 then determines whether the file format of the saved file is set as editable or uneditable. When the file format is set as editable, the save notification section 14 notifies the notification target of the path to the save folder in which the file is saved and the file name. When the file format is set as uneditable, the save notification section 14 notifies the notification target of the path to the file saved in the save folder. As a result, the same effects of the present embodiment are accomplished.

Note that the present disclosure is not limited to the above embodiment. It is clear that the embodiment may be appropriately altered within a scope of the technical concept of the present disclosure. Furthermore, the number, position, shape, and the like of constituent elements are not limited to the above embodiment and may be any number, position, shape, or the like suitable for implementing the present disclosure. Note that the same elements of configuration are affixed with the same reference signs in the drawings.

What is claimed is:

1. A data saving apparatus for saving data in a save folder which is one of a plurality of folders provided in a network storage area, the data saving apparatus comprising:
a data acquiring section configured to acquire the data and acquire settings of a file name, a file format, and the save folder, the save folder being a save target folder for the data;
a file generating section configured to generate a file with the file name and the file format for the data acquired by the data acquiring section;
a file saving section configured to save the file generated by the file generating section in the save folder; and
a save notification section configured to:
determine whether the file format is set as editable or uneditable;
notify a notification target of a path to the save folder in which the file is saved and the file name when the file format is set as editable; and
notify the notification target of a path to the file saved in the save folder when the file format is set as uneditable.

2. The data saving apparatus according to claim 1, further comprising
editability information storage that stores therein editability information in which the file format treated as editable and the file format treated as uneditable are set corresponding to each of the plurality of folders, wherein
the save notification section determines whether the file format is set as editable or uneditable based on the editability information corresponding to the save folder.

3. The data saving apparatus according to claim 1, further comprising
notification target information storage that stores therein notification target information in which the notification target is set corresponding to each of the plurality of folders, wherein
the save notification section determines the notification target based on the notification target information in which a notification target is set corresponding to the save folder.

4. The data saving apparatus according to claim 1, wherein
information indicating whether the file saved in the save folder is editable or uneditable is indicated in a notification by the save notification section.

5. The data saving apparatus according to claim 1, further comprising
an operation section configured to receive the settings of the file name, the file format, and the save folder.

6. The data saving apparatus according to claim 1, further comprising
a communication section configured to receive information indicating the settings of the file name, the file format, and the save folder.

7. A data saving apparatus for saving data in a save folder provided in a network storage area, the data saving apparatus comprising:
a data acquiring section configured to acquire the data and acquire settings of a file name and a file format;
a file generating section configured to generate a file with the file name and the file format for the data acquired by the data acquiring section;
a file saving section configured to save the file generated by the file generating section in the save folder; and
a save notification section configured to:
determine whether the file format is set as editable or uneditable;
notify a notification target of a path to the save folder in which the file is saved and the file name when the file format is set as editable; and
notify the notification target of a path to the file saved in the save folder when the file format is set as uneditable.
